(19) United States
(12) Patent Application Publication
(10) Pub. No.: US 2025/0232582 A1
(43) Pub. Date: Jul. 17, 2025

(54) COMPUTER SYSTEMS AND METHODS FOR LOCATING FIRST GENERATION MATERIAL IN DIGITAL FORENSIC INVESTIGATIONS OF DATA STORAGE DEVICES

(71) Applicant: Magnet Forensics Inc., Waterloo (CA)

(72) Inventors: Gwenyvere Darling, Hamilton (CA); Mark Thistle, Ottawa (CA); Xinwei Chen, Ottawa (CA)

(21) Appl. No.: 19/018,331

(22) Filed: Jan. 13, 2025

Related U.S. Application Data
(60) Provisional application No. 63/620,406, filed on Jan. 12, 2024.

(51) Int. Cl. G06V 20/30; G06F 16/535; G06V 10/56; G06V 10/74; G06V 10/764; G06V 10/82

(52) U.S. Cl. CPC G06V 20/30; G06F 16/535; G06V 10/56; G06V 10/74; G06V 10/764; G06V 10/82

(57) ABSTRACT

Computer systems and methods for detecting first generation illicit material on a target device are provided. The system includes a processor configured to execute a user interface module and an investigation module. The user interface module generates a user interface for interaction with a user. The investigation module: generates an investigation interface including input fields for prioritized folder data representing an ordered list of prioritized folders to scan for image files; searches the prioritized folders to locate image files; filters the image files using a plurality of filters each having filter criteria and rejects image files not meeting the filter criteria; scans, using an AI model, image files not rejected by the plurality of filters, wherein the AI model is trained to identify illicit material; flags possible first generation illicit material by the AI model; and displays the flagged possible first generation illicit material on the investigation interface.

### TECHNICAL FIELD

The following relates generally to digital forensic investigation of data storage devices, and more particularly to locating first generation or originating digital forensic data of a sensitive nature, such as illicit content or material, on data storage devices.

### INTRODUCTION

In a digital forensic investigation, an investigator must identify files and/or data from electronic storage media of a device of interest (“target device”) which are relevant to an investigation. Currently, searching methods include acquiring a digital forensic image of the target device and then searching or processing the acquired forensic image for forensically relevant data manually by an investigator inputting what they consider to be important search parameters. Case backlogs are high and the amount of data that must be searched for a single investigation can be immense. In some circumstances, minimizing the amount of time required to acquire relevant evidence is imperative. For example, in an Internet Crimes Against Children (ICAC) or child sexual abuse material (CSAM) case, the abuse may still be occurring, and quick discovery of digital evidence may prevent further abuse of victims. First generation digital material (i.e., digital material, such as media files, originating on the target device) are indicative of current abuse, and thus are of particular interest and value in digital forensic investigations. Current methods of identifying first generation digital material require a full scan of a device, which can take hours or days, and are carried out at an Agency lab and not at the scene of a Warrant Search.

Accordingly, there is a need for systems and methods which allow for efficient location of digital forensic data corresponding to first generation material on data storage devices that overcome at least some of the disadvantages of existing systems and methods.

### SUMMARY

Provided herein is a computer system for detecting first generation illicit material on a target device, the system comprising a processor configured to execute: a user interface module configured to generate a user interface for interaction with a user; an investigation module configured to generate an investigation interface including input fields for prioritized folder data, wherein the prioritized folder data represents an ordered list of prioritized folders to scan for image files, search the prioritized folders to locate image files, filter the image files using a plurality of filters each having filter criteria and reject image files which do not meet the filter criteria, scan image files which were not rejected by the plurality of filters using an AI model, wherein the AI model is trained to identify illicit material and flag possible first generation illicit material by the AI model and display the flagged possible first generation illicit material on the investigation interface.

The plurality of filters may include at least one of: an exchangeable image file (EXIF) filter wherein image files which match EXIF data associated with the target device are automatically scanned by the AI model, image files which have EXIF data which does not match the EXIF data associated with the target device are rejected, and image files which do not have EXIF data are not rejected, a size filter which filters the image files based on size threshold filter criteria, wherein image files with a size at or under the size threshold are rejected, and image files with a size over the size threshold are not rejected, a color filter which filters the image files based on color depth filter criteria, wherein image files with a color depth at or under the color depth threshold are rejected, and image file with a color depth above the color depth threshold are not rejected, and a known illicit material filter which filters image files based on known illicit images, wherein image files which match known illicit material are rejected, and image files which do not match known illicit material are not rejected.

The plurality of filters may include the EXIF filter and at least one other filter and the EXIF filter may be applied first.

The plurality of filters may include the EXIF filter, the size filter, the color filter, and the known illicit material filter, wherein only images which do not have EXIF data are filtered by the size filter, wherein only images which do not have EXIF data and are over the size threshold are filtered by the color filter, wherein only which are filtered by the known illicit material filter, and wherein only images which do not have EXIF data, are over the size filter, are over the color filter or do not have color, and do not match known illicit material are scanned by the AI model.

The image files which are found to match the EXIF data associated with the target device may be immediately scanned by the AI model.

The image files may be filtered in real time as the image files are located on the target device.

The AI model may be a child sexual abuse material (CSAM) model configured to receive a digital image as input and classify the digital image as CSAM or not CSAM.

Any folders or file location which were not included in the prioritized folders are scanned after the image files in the prioritized folders have been filtered and scanned.

The AI model may be a deep learning neural network trained on known illicit material, the deep learning neural network comprising an input layer for receiving an input image, one or more hidden layers, and an output layer configured to assign a class label to the input image, wherein the class label identifies the input image as illicit material or not illicit material.

The investigation module may be further configured to scan image files which were not rejected by the plurality of filters using a skin tone detection model.

The skin tone detection model may flag image files as possible first generation illicit material based on a skin tone pixel threshold, wherein image files which contain skin tone pixels at or above the skin tone pixel threshold are flagged as possible first generation illicit material.

The image files which were not rejected by plurality of filters may be randomly organized in a queue to be scanned by the AI model.

When an image file is flagged as possible first generation material by the AI model, image files in the same location as the flagged image file may be scanned before other image files in the queue.

Provided herein is a method of detecting first generation illicit material, the method comprising: generating, by at least one processor, a user interface including input fields for receiving prioritized folder data from a user, wherein the prioritized folder data represents an ordered list of prioritized folders to scan for image files, searching, by the at least one processor, the prioritized folders to locate image files, filtering, by the at least one processor, the image files using a plurality of filters each having filter criteria, rejecting, by the at least one processor, image files which do not meet the filter criteria, scanning image files which were not rejected by the plurality of filters using an AI model executed by the at least one processor, wherein the AI model is trained to identify illicit material, flagging, by the at least one processor, possible first generation illicit material by the AI model; and displaying, on a display device, the flagged possible first generation illicit material on the user interface.

The plurality of filters may include at least one of: an exchangeable image file (EXIF) filter wherein image files which match EXIF data associated with the target device are automatically scanned by the AI model, image files which have EXIF data which does not match the EXIF data associated with the target device are rejected, and image files which do not have EXIF data are not rejected, a size filter which filters the image files based on size threshold filter criteria, wherein image files with a size at or under the size threshold are rejected, and image files with a size over the size threshold are not rejected, a color filter which filters the image files based on color depth filter criteria, wherein image files with a color depth at or under the color depth threshold are rejected, and image file with a color depth above the color depth threshold are not rejected, and a known illicit material filter which filters image files based on known illicit images, wherein image files which match known illicit material are rejected, and image files which do not match known illicit material are not rejected.

The plurality of filters may include the EXIF filter and at least one other filter and the EXIF filter may be applied first.

The plurality of filters may include the EXIF filter, the size filter, the color filter, and the known illicit material filter, wherein only images which do not have EXIF data are filtered by the size filter, wherein only images which do not have EXIF data and are over the size threshold are filtered by the color filter, wherein only which are filtered by the known illicit material filter, and wherein only images which do not have EXIF data, are over the size filter, are over the color filter or do not have color, and do not match known illicit material are scanned by the AI model.

The image files which are found to match the EXIF data associated with the target device may be immediately scanned by the AI model.

The image files may be filtered in real time as the image files are located on the target device.

The AI model may be a child sexual abuse material (CSAM) model configured to receive a digital image as input and classify the digital image as CSAM or not CSAM.

Folders or file location which were not included in the prioritized folders may be scanned after the image files in the prioritized folders have been filtered and scanned.

The AI model may be a deep learning neural network trained on known illicit material, the deep learning neural network comprising an input layer for receiving an input image, one or more hidden layers, and an output layer configured to assign a class label to the input image, wherein the class label identifies the input image as illicit material or not illicit material.

The method may further comprise scanning image files which were not rejected by the plurality of filters using a skin tone detection model.

The method may further comprise flagging image files as possible first generation illicit material based on a skin tone pixel threshold, wherein image files which contain skin tone pixels at or above the skin tone pixel threshold are flagged as possible first generation illicit material.

The method may further comprise randomly organizing image files which were not rejected by plurality of filters into a queue to be scanned by the AI model.

An image file may be flagged as possible first generation material by the AI model, image files in the same location as the flagged image file are scanned before other image files in the queue.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a block diagram of a computer system for identifying first generation CSAM on a data storage device, according to an embodiment;

FIG. 2 is a block diagram of an investigator device for identifying first generation CSAM on a target device, according to an embodiment;

FIG. 3 is a flow diagram of a method of scanning electronic storage media of a target device for first generation digital material, according to an embodiment; and

FIG. 4 is a flow diagram of a method of filtering a plurality of digital images identified on a target device, according to an embodiment.

FIG. 5 is a flow diagram of an example method of filtering a plurality of digital images identified on a target device, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods, and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of more than one device or article.

Generally, as used herein, the term “target device” refers to any device capable of storing data in electronic storage media (or data storage device) and which is subject to a digital forensic investigation. Generally, a digital forensic investigation refers to the processing of one or more target devices to acquire, collect, refine, or extract data that is relevant or potentially relevant to an investigation. The term “target dataset” refers to a collection of electronically stored information or data stored on the electronic storage media of the target device, of which a subset may be acquired from the target device and subsequently processed and analyzed for digital forensic investigation. Generally, a target dataset may be acquired from a target device and a forensic data collection generated therefrom, which may include the target dataset in its acquired form along with forensic data artifacts extracted therefrom and analysis outputs generated from the extracted forensic data artifacts. Forensic data artifacts may be categorized by artifact type. For example, artifact types may include image type artifacts, chat type artifacts, document type artifacts, etc. Refining modules may be used and specifically configured to extract data from the target dataset and generate an artifact of a particular type.

Herein, “data item”, “data items”, or similar are discussed. It is to be understood that these terms may include complete files but also encompasses data, metadata, partial files, hashes of files, reduced size files, or any other such information that can be scanned within the target dataset and may be useful to a digital forensic investigation.

The present disclosure provides systems and methods that enable quick locating of first generation CSAM or other sensitive digital content stored on a target device by locating a plurality of images in prioritized folders on the target device, rejecting images based on pre-determined rejection filters, randomly queueing the remaining (non-rejected) images of the plurality of images and scanning the remaining images for CSAM, flagging images which are possibly first generation CSAM, and then scanning images which are “near” the flagged images before the rest of the queue. The systems and methods can be used and performed at the scene of an investigation to minimize the time to discovery of first generation digital materials.

The embodiments herein generally discuss CSAM but could be applied to any investigation in which digital materials including nudity or CSAM may be involved. While the embodiments described herein refer to the searching, locating, and extracting of CSAM-related digital forensic data, it is to be understood that, in other embodiments, the systems and methods described herein may be used to search, locate, and extract other types of sensitive digital forensic data.

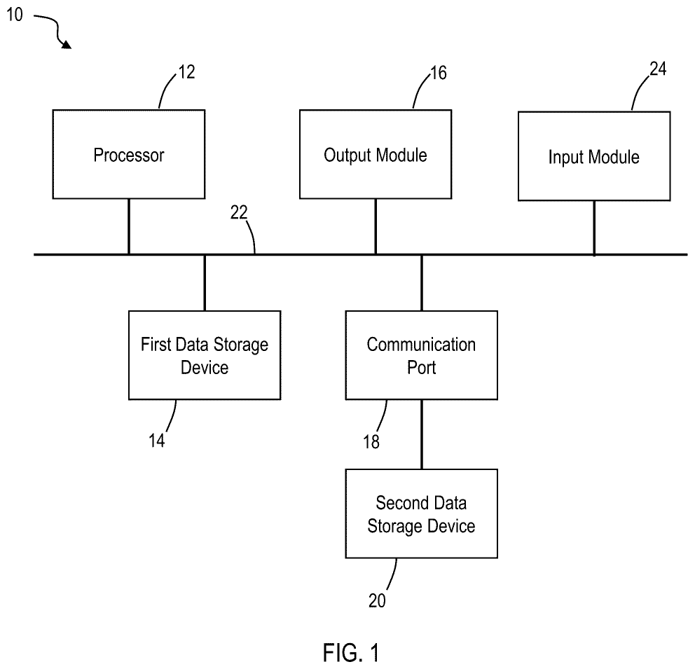

Referring now to FIG. 1, shown therein is a computer system 10 for identifying first generation CSAM on a data storage device, according to an embodiment.

The system 10 includes a processor 12, a first data storage device 14, an output module 16, a communication port 18, a second data storage device 20 coupled to the communication port 20 and an input module 24. In this embodiment, the various components 12, 14, 16, 18, and 24 of the system 10 are operatively coupled using a system bus 22.

The system 10 may be various electronic devices such as personal computers, networked computers, portable computers, portable electronic devices, personal digital assistants, laptops, desktops, mobile phones, smart phones, tablets, and so on.

In some examples, the first data storage device 14 may be a hard disk drive, a solid-state drive, or any other form of suitable data storage device and/or memory that may be used in various electronic devices. The data storage device 14 may have various data stored thereon. Generally, the data stored on the data storage device 14 includes data that may be of forensic value to a digital forensic investigation and from which forensic artifacts can be recovered or extracted and then processed or analyzed (e.g., ranked or scored according to relevance) and displayed in a graphical user interface.

In the embodiment as shown, another data storage device in addition to the first data storage device 14, namely the second data storage device 20, is provided. The second data storage device 20 may be used to store computer-executable instructions that can be executed by the processor 12 to configure the processor 12 to locate and acquire target first generation digital material and display acquired data in a user interface based on data stored in the data storage device 14 or of data acquired from the first data storage device 14 and stored in the second data storage device 20.

It should be noted that it is not necessary to provide a second data storage device, and in other embodiments, the instructions may be stored in the first data storage device 14 or any other data storage device.

In some cases, the first data storage device 14 may be a data storage device external to the system 10 or processor 12. For example, the first data storage device 14 may be a data storage component of an external computing device (e.g., a data server) that stores forensic evidence for subsequent processing and display. In such cases, the processor 12 may be configured to execute computer-executable instructions (stored in second data storage device 20) to acquire digital forensic evidence of the first data storage device 14 and store the digital forensic evidence in the second data storage device 20.

The processor 12 may be configured to provide a user interface to the output module 16. The output module 16, for example, may be a suitable display device, and/or output device coupled to the processor 12. The display device may include any type of device for presenting visual information. For example, the display device may be a computer monitor, a flat-screen display, a projector, or a display panel. The output device may include any type of device for presenting a hard copy of information, such as a printer for example. The output device may also include other types of output devices such as speakers, for example. The user interface allows the processor 12 to solicit input from a user regarding various types of operations to be performed by the processor 12. The user interface also allows for the display of various output data and selections, such as case type selections and other data inputs and timeline or map visualizations of surfaced data artifacts, generated by the processor 12.

The input module 24 may include any device for entering information into system 10. For example, input module 24 may be a keyboard, keypad, cursor-control device, touchscreen, camera, or microphone. It will be appreciated that in certain embodiments the input module 24 and the output module 16 are the same device. As an example, the input module 24 and the output module 16 may be a single touchscreen, or a smart speaker.

The system 10 may be a purpose-built machine designed specifically for surfacing and displaying first generation material from a target device. In some cases, system 10 may include multiple of any one or more of processors, applications, software modules, second storage devices, network connections, input devices, output devices, and display devices.

The system 10 may be a server computer, desktop computer, notebook computer, tablet, PDA, smartphone, or another computing device. The system 10 may include a connection with a network such as a wired or wireless connection to the Internet. In some cases, the network may include other types of computer or telecommunication networks. The system 10 may include one or more of a memory, a secondary storage device, a processor, an input device, a display device, and an output device. Memory may include random access memory (RAM) or similar types of memory. Also, memory may store one or more applications for execution by processor. Applications may correspond with software modules comprising computer executable instructions to perform processing for the functions described below. Secondary storage devices may include a hard disk drive, floppy disk drive, CD drive, DVD drive, Blu-ray drive, or other types of non-volatile data storage. Processor 12 may execute applications, computer readable instructions or programs. The applications, computer readable instructions or programs may be stored in memory or in secondary storage or may be received from the Internet or other network.

Although system 10 is described with various components, one skilled in the art will appreciate that the system 10 may in some cases contain fewer, additional, or different components. In addition, although aspects of an implementation of the system 10 may be described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling the system 10 and/or processor 12 to perform a particular method.

In the description that follows, devices such as system 10 are described performing certain acts. It will be appreciated that any one or more of these devices may perform an act automatically or in response to an interaction by a user of that device. That is, the user of the device may manipulate one or more input devices (e.g., a touchscreen, a mouse, or a button) causing the device to perform the described act. In many cases, this aspect may not be described below, but it will be understood.

As an example, a user using the system 10 may manipulate one or more input devices (not shown; e.g., a mouse and a keyboard) to interact with a user interface displayed on a display of the system 10. In some cases, the system 10 may generate and/or receive a user interface from the network (e.g., in the form of a webpage). Alternatively, or in addition, a user interface may be stored locally at a device (e.g., a cache of a webpage or a mobile application).

In response to receiving information, the system 10 may store the information in storage database. The storage may correspond with secondary storage of the system 10. Generally, the storage database may be any suitable storage device such as a hard disk drive, a solid state drive, a memory card, or a disk (e.g., CD, DVD, or Blu-ray etc.). Also, the storage database may be locally connected with the system 10. In some cases, the storage database may be located remotely from system 10 and accessible to system 10 across a network for example. In some cases, the storage database may comprise one or more storage devices located at a networked cloud storage provider.

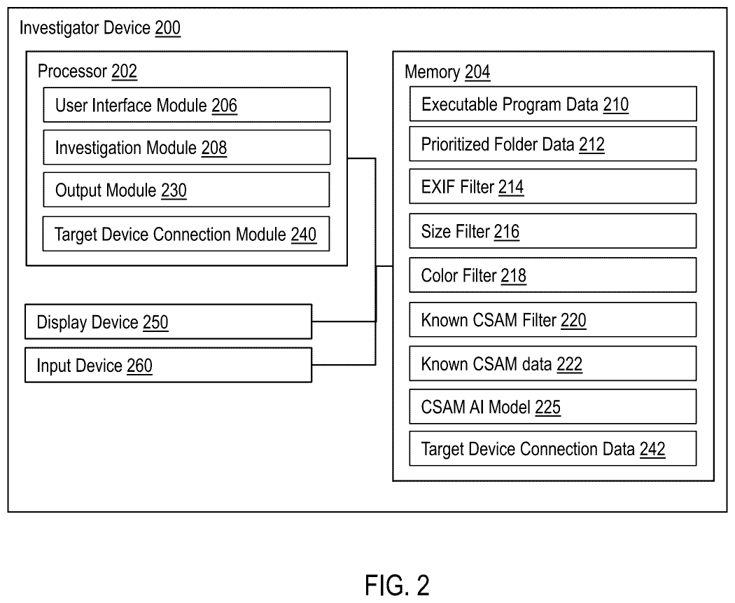

Referring now to FIG. 2, therein is shown a block diagram of an investigator device 200 for identifying first generation digital CSAM on a target device, according to an embodiment. The investigator device 200 may be implemented by the computer system 10 of FIG. 1.

Investigator device 200 includes a processor 202, memory 204, display device 250, and input device 260.

The processor 202 includes a user interface module 206, an investigation module 208, an output module 230, and target device connection module 240.

The memory 204 includes executable program data 210, prioritized folder data 212, exchangeable image file (EXIF) filter 214, size filter 216, color filter 218, known CSAM filter 220, known CSAM data 222, CSAM artificial intelligence (AI) Model 225, and target device connection data 242.

The user interface module 206 is configured to generate a user interface which enables the user (hereafter investigator) of the investigator device 200 to interact with the various modules and software on the investigator device 200 to perform a digital forensic investigation. The user interface module 206 also allows the investigator to interact with the various modules and data on the investigator device 200 when the investigator is not performing a digital forensic investigation. The user interface is displayed via display 250.

The instructions and data required to run the modules of processor 202 are stored as executable program data 210 in memory 204.

The investigation module 208 along with the user interface module 206 provides a digital forensic investigation interface which enables an investigator to input information about an investigation, including prioritized folder data 212 representing an ordered list of folders to scan for images, and to view information about the investigation. Information about the investigation can be input through input device 260 (e.g., via a keyboard).

The executable program data 208 provides instructions to evidence module 224 to carry out an investigation using the prioritized folder data 212, the exchangeable image file (EXIF) filter 214, the size filter 216, the color filter 218, the known CSAM filter 220, and the known CSAM data 222.

The target device connection module 240 enables the computer system to connect to the target device to search the data on the target device for forensic data of potential evidentiary relevance. Any target device connection data 242 required to establish a connection to the target device is stored in the memory 204. The target device may be a device such as a mobile device, laptop, desktop, or external hard drive. The target device may be a seized device (e.g., seized from a suspect).

The investigation module 208 accesses the prioritized folder data 212 and scans the prioritized folders of the target device for digital images. The prioritized folder data 212 represents an ordered list of folders to scan for images. The prioritized folders may include, for example, a default camera folder, a gallery folder, a videos folder, and a documents folder of the target device.

When images are identified in the prioritized folders, the investigation module 208 applies one or more rejection filters to the images to reject images which are not likely to be first generation CSAM. The filters are applied as images are identified to enable a search that can find possible first generation CSAM as quickly as possible. That is, filtering and image identification in the prioritized folders occurs simultaneously.

EXIF filter 214 is applied to the images and any images which have EXIF data that does not match EXIF data associated with the target device being scanned are rejected. If a file does not have any EXIF data, the file is not rejected by the EXIF filter.

The EXIF filter 214 may include EXIF information for a single device associated with the target device or for multiple devices associated with the target device. That is, the EXIF data for any device known to be associated with the suspect or the investigation may be used in the EXIF filter 214 to find images with matching EXIF data on the target device. For example, the target device may be a laptop of a suspect and the EXIF filter 214 may search for images matching the EXIF data of a smartphone or a digital camera known to belong to the suspect. In another example, the EXIF filter 214 may be applied to a smartphone of a suspect and may only search for images matching the EXIF data of the smartphone. The EXIF data of each device associated with the investigation may be added to the EXIF filter 214 using input fields.

Images with matching EXIF data as determined by the EXIF filter 214 are randomly queued to be scanned by the investigation module 208 using the CSAM AI Model 225 for possible nudity, as described further below.

Images with no EXIF data are subjected to further filtering, as described below.

Size filter 216 is applied to the images which do not have any EXIF data and rejects images that do not meet a minimum image size threshold. Image files that do not meet the minimum image size threshold are considered too small to contain a full image. In an embodiment, the minimum image size threshold may be 299×299 pixels.

Color filter 218 is applied to the remaining (not rejected by size filter 216) images and rejects images that have a colour depth that does not meet a minimum colour depth threshold. Image files with a colour depth below the minimum colour depth threshold are not considered photographic quality and therefore are unlikely to be first generation CSAM (or other illicit material). In an embodiment, the minimum colour depth threshold may be 24 bit depth. If an image has no color depth, the image is not rejected by the color filter 218.

Known CSAM filter 220 is applied to the remaining (not rejected color filter 218) images and rejects images which are already known CSAM. The known CSAM filter 220 may compare the image, or data associated therewith or generated therefrom, to a set of reference data corresponding to known CSAM images (known CSAM data 222). Known CSAM data 222 may include CRC Neula, a hash list, or a database of known files. In an embodiment, the known CSAM filter 220 generates a hash of an image in the remaining images and compares the hash value to a set of reference hash values corresponding to known CSAM and either rejects the image (if the hash value matches a reference hash in the reference hash set) or does not reject the image (if the hash value does not match a reference hash in the reference hash set).

While, in variations, the filters 214, 216, 218, 220 may be applied in any order, using the filters in a specific order, such as EXIF 214, then size 216 or color 218, then known CSAM 220, may decrease the time to find first generation material as each subsequent filter is applied to a smaller pool of images and, for example, scanning EXIF data is quicker than comparing an image to other images. The EXIF data is represented as a string while the size and color data are represented as integers. Accordingly, filtering EXIF data is quicker than filtering for size or color. Filtering size and then color, or color and then size may be interchangeable in terms of the amount of time involved. Generating hashes for the known CSAM filter 220 is the most time consuming of the filters.

The EXIF-matching images and the “remaining images”, which are those located images that have not been rejected by the size filter 216, color filter 218, and known CSAM filter 220 filter, are randomly queued to be scanned by the investigation module 208 using the CSAM AI Model 225 for possible nudity or CSAM. The investigation module 208 may also use a skin tone detection algorithm. The queue is stored in a memory of the investigator device. When it is determined by the investigation module 208 that a scanned image contains possible CSAM, the investigation module 208 flags the image as possible first generation CSAM and removes the image from the queued images still to be scanned. The scanning of EXIF-matching images by the investigation module 208 occurs as soon as an image is identified as EXIF-matching. Therefore, EXIF-matching images may be scanned by the investigation module 208 while the images with no EXIF data are being filtered by the size filter 216, color filter 218, and known CSAM filter 220. All steps may be performed as soon as possible within the investigation so that first generation CSAM can be identified as quickly as possible.

The CSAM AI model 225 may be a deep learning neural network. The CSAM AI model 225 may be trained on known CSAM (training data/images), such as CSAM held by law enforcement or similar agencies. In an embodiment, a base model is created from the known CSAM and then training scripts are used so a user (e.g., a particular law enforcement organization, or similar) can check the accuracy of the model. Once the model performs well enough, i.e., accurately predicts CSAM based on certain criteria (e.g., a certain false positive rate is reached), other users (e.g., other law enforcement agencies or similar) may test the model as well.

The skin tone detection model detects possible CSAM by determining whether a threshold percentage of pixels match known skin tone colors. Where the skin tone model determines that an image contains skin tone pixels at or above the threshold percentage, the skin tone detection model tags the image as possible nudity.

In some embodiments, the CSAM AI Model and the skin tone detection model may be applied to each of the images to be scanned by the investigation module 208 to detect possible CSAM. However, applying both models in such a manner increases time to scan compared to time to scan when scanning with just one of the models. The CSAM AI Model may be preferred when only one model is used.

When an image is flagged as possible first generation CSAM by the investigation module 208, any images still within the queue that are located “near” the flagged image on the data storage device are pulled out of the queue and scanned by the CSAM AI Model 225 “outward” from the flagged image. That is, images which were in the same folder or location on the target device are scanned before images that were not. The search is performed this way because images are often organized together by perpetrators.

When an image is flagged, the user interface module 206 may immediately generate a user interface reporting the flagged image and display the user interface on the display device 250. This beneficially brings the flagged image to the attention of the user running the search as soon as possible. The flagged image may be reported through output module 230.

The output module 230 may also generate reports or other outputs based on the scan of the target device.

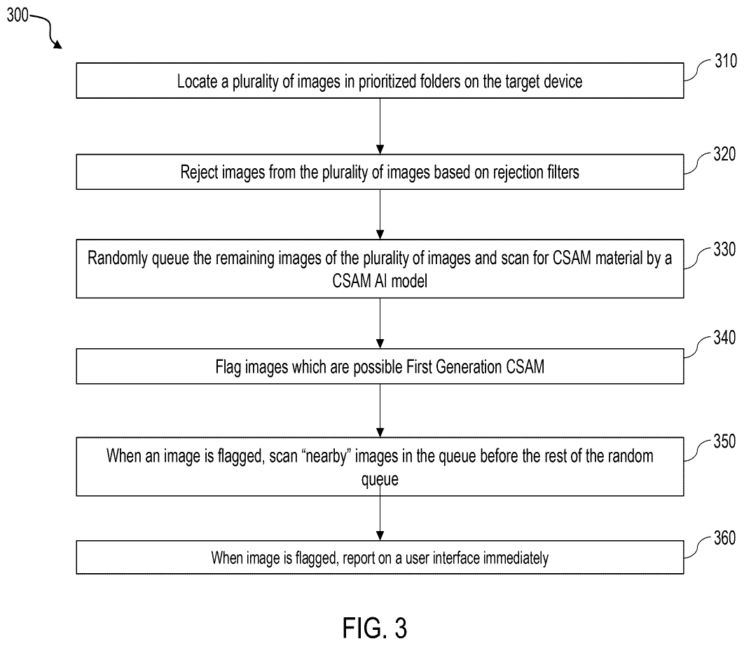

Referring now to FIG. 3, shown therein is a flow diagram of a method 300 of scanning a target device for first generation digital material, according to an embodiment. The method 300 is performed by a computing device, such as investigator device 200 of FIG. 2.

At 310, the target device is scanned by the investigator device to locate a plurality of images (likely a plurality of images but possibly could be a single image or no images on the target device) in a plurality of folders stored on the target device.

The folders are searched according to a prioritized order of folders. The prioritized order of folders is based on where illicit material images are most likely to be stored. The prioritized folders may include, for example, a default camera folder, a gallery folder, a video folder, and a documents folder.

Any remaining folders that are not included in the prioritized order may be scanned following the scanning of the prioritized folders.

In some cases, the folders and/or the order may be configured by a user through a user interface. In other cases, the folders and/or the order may be preconfigured.

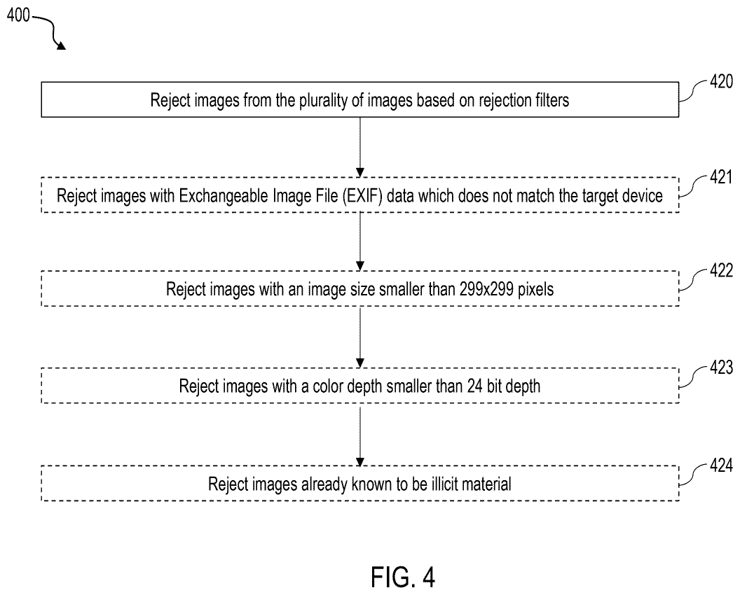

At 320, the plurality of images are filtered by a plurality of rejection filters to reject images that are not likely to be first generation digital material and surface images that are more likely to be first generation material. The rejection filters are based on various parameters and characteristics of the image (see FIG. 2 above, and FIG. 4 below). Each image of the plurality of images is filtered immediately upon being located. That is, the filters are applied in real time as the images are located and not after all of the prioritized folders or the entire target device has been searched for images.

At 330, the images that have not been rejected (i.e., those candidate images that have been surfaced by filtering) are randomly queued and scanned in the random queued order for CSAM or other illicit material by an AI model trained to recognize nudity, CSAM, or other illicit material.

At 340, scanned images which are determined to be possible first generation digital material by the AI model are flagged as potential first generation material.

At 350, when an image is flagged, images that are “near” the flagged image on the target device are scanned next. That is, images which are in the same folder on the target device as the flagged image are scanned by the AI model before any other images in the randomly ordered queue, as these images are presumed more likely to also be illicit material. In other embodiments “near” may not be based on proximity within a folder but may be based on proximity in time, i.e., images which have similar dates/times of creation (i.e., creation time metadata associated with the images) may be scanned next regardless of which folder they are found in.

At 360, possible first generation images that have been flagged are reported on the user interface immediately. As the presence of first generation CSAM may be associated with current and ongoing abuse, any possible first generation material needs to be brought to the attention of investigators as soon as possible. Therefore, flagged images are reported immediately and not at the end of scanning all images.

Referring now to FIG. 4, therein is shown a flow diagram of a method 400 of filtering a plurality of images discovered on a target device, according to an embodiment.

Method 400 represents the filtering steps of step 320 of FIG. 3.

At 420, as at 320 above, the plurality of images are filtered by rejection filters to reject images which are not likely to be first generation material. The rejection filters are based on various parameters and characteristics of the image and are discussed in substeps 421-424 below.

At 421, an exchangeable image file data (EXIF) filter, such as EXIF filter 214 of FIG. 2, is applied to the images. As above, any images that have EXIF data that does not match EXIF data associated with the target device are rejected. EXIF data associated with the target device may be EXIF data of the target device or may be EXIF data known to belong to or be used by a suspect. The EXIF data associated with the target device may include EXIF data for multiple devices. If a file does not have any EXIF data, the file is not rejected by the EXIF filter. The images that match the EXIF data associated with the target device are not filtered further but are immediately scanned by a CSAM AI Model and/or a skin tone detection model to determine if the EXIF-matching images are first generation CSAM. The images that do not have EXIF data are filtered further at steps 422-424.

At 422, a size filter, such as size filter 216 of FIG. 2, is applied to the remaining (no-EXIF data) images and any images that are smaller than a minimum image size threshold are rejected. Files small than the minimum size threshold are considered too small to contain a full image. The threshold may be 299×299 pixels.

At 423, a color filter, such as color filter 218 of FIG. 2, is applied to the remaining (no-EXIF data, above the size threshold) images and any images that have a color depth below a color depth threshold are rejected. Files with a color depth below the color depth threshold are not considered photographic quality, and therefore are unlikely to be first generation CSAM (or other illicit material). The color threshold may be 24 bit depth. If an image has no color depth, the image is not rejected by the color filter.

At 424, a known CSAM filter, such as known CSAM filter 220, is applied to the remaining (not rejected) images and any images that are already known CSAM are rejected. The images may be compared to known CSAM data, such as data 222 of FIG. 2. The known CSAM data may include CRC Neula, a Hash list, or a database of known files.

The filters may be applied in any order, however, using the filters in a specific order, such as EXIF, then size, then color, then known CSAM, may decrease the time to find first generation material as each subsequent filter is applied to a smaller pool of images and, for example, scanning EXIF data is quicker than comparing an image to other images.

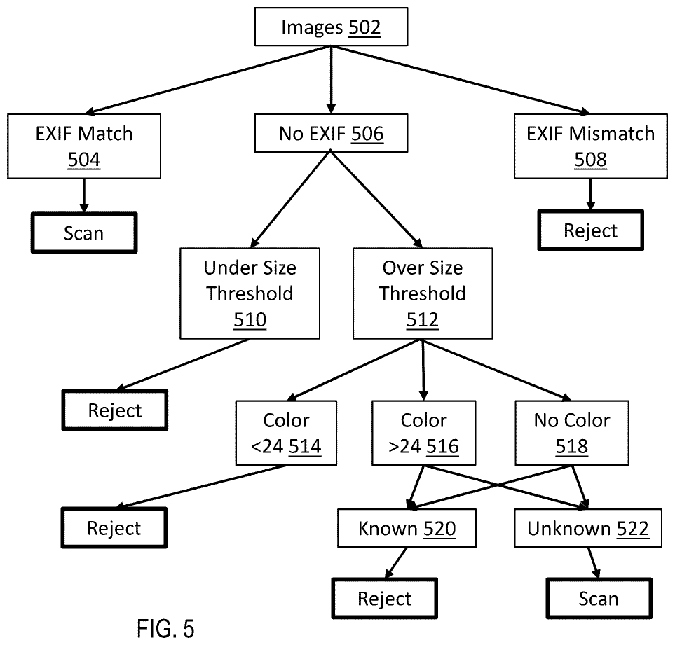

FIG. 5 is a flow diagram of an example method 500 of filtering a plurality of digital images identified on a target device, according to an embodiment. FIG. 5 shows a workflow of the application of filters to a plurality of images 502. Each box in the workflow represents either a group of images (numbered) or an action taken for a group of images (bold lines).

The plurality of images 502 that have been identified from the target device are first filtered for EXIF data known to be associated with the target device (i.e., EXIF data for the target device if the target device includes a camera and/or EXIF data for other camera devices of a user(s) associated with the target device).

Filtering for EXIF data results in three separate image groups: EXIF match 504 comprising image files which match EXIF data associated with the target device, no EXIF 506 comprising image files which do not have EXIF data, and EXIF mismatch 508 comprising image files which have EXIF data that does not match the EXIF data associated with the target device.

The EXIF match image files 504 are immediately scanned by a CSAM AI model and/or a skin tone detection model.

The EXIF mismatch image files 508 are determined to not be first generation CSAM material and rejected for any further filtering or scanning (‘Reject”).

The no EXIF image files 506 are filtered by size according to a specific size threshold, for example 299×299 pixels. Size filtering results in two separate image groups: an under size threshold 510 group comprising image files which have a file size less than or equal to the file size threshold, and an over size threshold 512 group comprising image files which have a file size greater than the file size threshold.

The under size threshold image files 510 are considered too small to be full image files and are rejected for any further filtering or scanning (“Reject”).

The over size threshold image files 512 are further filtered for color using a color depth threshold, for example, 24 bit color depth.

Color filtering may result in three separate image groups: color <24 image files 514 with colors which have color depth less than 24 bit (and equal to 24 bit), color >24 image files 516 which have color depth greater than 24 bit, and no color image files 518 which have no color depth such as black and white or grayscale image files.

Color <24 image files 514 with a color depth below the minimum color depth threshold are not considered photographic quality and therefore are unlikely to be first generation CSAM (or other illicit material) and are rejected for any further filtering or scanning (“Reject”).

Color >24 image files 516 and no color image files 518 are further filtered by comparing to known CSAM material. The image files are filtered into two separate groups: known image files 520 and unknown image files 522.

Known image files 520 are likely not first generation CSAM and are rejected for further scanning (“Reject”).

Unknown image files 522 are immediately scanned by a CSAM AI model and/or a skin tone detection model.

Any of the EXIF match image files 504 and unknown image files 522 that are determined to be potential CSAM by the CSAM AI model or images including nudity by the skin tone detection model are flagged as first generation CSAM or illicit material.

While the above description provides examples of one or more apparatus, methods, or systems, it will be appreciated that other apparatus, methods, or systems may be within the scope of the claims as interpreted by one of skill in the art.

1. A computer system for detecting first generation illicit material on a target device, the system comprising:
a processor configured to execute:
a user interface module configured to generate a user interface for interaction with a user; and
an investigation module configured to:
generate an investigation interface including input fields for prioritized folder data, wherein the prioritized folder data represents an ordered list of prioritized folders to scan for image files;
search the prioritized folders to locate image files;
filter the image files using a plurality of filters each having filter criteria and reject image files which do not meet the filter criteria;
scan image files which were not rejected by the plurality of filters using an AI model, wherein the AI model is trained to identify illicit material; and
flag possible first generation illicit material by the AI model and display the flagged possible first generation illicit material on the investigation interface.

2. The system of claim 1, wherein the plurality of filters include at least one of:
an exchangeable image file (EXIF) filter wherein image files which match EXIF data associated with the target device are automatically scanned by the AI model, image files which have EXIF data which does not match the EXIF data associated with the target device are rejected, and image files which do not have EXIF data are not rejected;
a size filter which filters the image files based on size threshold filter criteria, wherein image files with a size at or under the size threshold are rejected, and image files with a size over the size threshold are not rejected;
a color filter which filters the image files based on color depth filter criteria, wherein image files with a color depth at or under the color depth threshold are rejected, and image file with a color depth above the color depth threshold are not rejected; and
a known illicit material filter which filters image files based on known illicit images, wherein image files which match known illicit material are rejected, and image files which do not match known illicit material are not rejected.

3. The system of claim 2, wherein the plurality of filters include the EXIF filter, the size filter, the color filter, and the known illicit material filter, wherein only images which do not have EXIF data are filtered by the size filter, wherein only images which do not have EXIF data and are over the size threshold are filtered by the color filter, wherein only which are filtered by the known illicit material filter, and wherein only images which do not have EXIF data, are over the size filter, are over the color filter or do not have color, and do not match known illicit material are scanned by the AI model.

4. The system of claim 1, wherein the AI model is a child sexual abuse material (CSAM) model configured to receive a digital image as input and classify the digital image as CSAM or not CSAM.

5. The system of claim 1, wherein any folders or file location which were not included in the prioritized folders are scanned after the image files in the prioritized folders have been filtered and scanned.

6. The system of claim 1, wherein the AI model is a deep learning neural network trained on known illicit material, the deep learning neural network comprising an input layer for receiving an input image, one or more hidden layers, and an output layer configured to assign a class label to the input image, wherein the class label identifies the input image as illicit material or not illicit material.

7. The system of claim 1, wherein the investigation module is further configured to scan image files which were not rejected by the plurality of filters using a skin tone detection model.

8. The system of claim 7, wherein the skin tone detection model flags image files as possible first generation illicit material based on a skin tone pixel threshold, wherein image files which contain skin tone pixels at or above the skin tone pixel threshold are flagged as possible first generation illicit material.

9. The system of claim 8, wherein when an image file is flagged as possible first generation material by the AI model, image files in the same location as the flagged image file are scanned before other image files in the queue.

10. A method of detecting first generation illicit material, the method comprising:
generating, by at least one processor, a user interface including input fields for receiving prioritized folder data from a user, wherein the prioritized folder data represents an ordered list of prioritized folders to scan for image files;
searching, by the at least one processor, the prioritized folders to locate image files;
filtering, by the at least one processor, the image files using a plurality of filters each having filter criteria;
rejecting, by the at least one processor, image files which do not meet the filter criteria;
scanning image files which were not rejected by the plurality of filters using an AI model executed by the at least one processor, wherein the AI model is trained to identify illicit material;
flagging, by the at least one processor, possible first generation illicit material by the AI model; and
displaying, on a display device, the flagged possible first generation illicit material on the user interface.

11. The method of claim 10, wherein the plurality of filters include at least one of:
an exchangeable image file (EXIF) filter wherein image files which match EXIF data associated with the target device are automatically scanned by the AI model, image files which have EXIF data which does not match the EXIF data associated with the target device are rejected, and image files which do not have EXIF data are not rejected;
a size filter which filters the image files based on size threshold filter criteria, wherein image files with a size at or under the size threshold are rejected, and image files with a size over the size threshold are not rejected;
a color filter which filters the image files based on color depth filter criteria, wherein image files with a color depth at or under the color depth threshold are rejected, and image file with a color depth above the color depth threshold are not rejected; and
a known illicit material filter which filters image files based on known illicit images, wherein image files which match known illicit material are rejected, and image files which do not match known illicit material are not rejected.

12. The method of claim 11, wherein the plurality of filters include the EXIF filter and at least one other filter and the EXIF filter is applied first.

13. The method of claim 11, wherein the plurality of filters include the EXIF filter, the size filter, the color filter, and the known illicit material filter, wherein only images which do not have EXIF data are filtered by the size filter, wherein only images which do not have EXIF data and are over the size threshold are filtered by the color filter, wherein only which are filtered by the known illicit material filter, and wherein only images which do not have EXIF data, are over the size filter, are over the color filter or do not have color, and do not match known illicit material are scanned by the AI model.

14. The method of claim 10, wherein the AI model is a child sexual abuse material (CSAM) model configured to receive a digital image as input and classify the digital image as CSAM or not CSAM.

15. The method of claim 10, wherein any folders or file location which were not included in the prioritized folders are scanned after the image files in the prioritized folders have been filtered and scanned.

16. The method of claim 10, wherein the AI model is a deep learning neural network trained on known illicit material, the deep learning neural network comprising an input layer for receiving an input image, one or more hidden layers, and an output layer configured to assign a class label to the input image, wherein the class label identifies the input image as illicit material or not illicit material.

17. The method of claim 10, further comprising scanning image files which were not rejected by the plurality of filters using a skin tone detection model.

18. The method of claim 17, further comprising flagging image files as possible first generation illicit material based on a skin tone pixel threshold, wherein image files which contain skin tone pixels at or above the skin tone pixel threshold are flagged as possible first generation illicit material.

19. The method of claim 10, further comprising randomly organizing image files which were not rejected by plurality of filters into a queue to be scanned by the AI model.

20. The method of claim 19, wherein when an image file is flagged as possible first generation material by the AI model, image files in the same location as the flagged image file are scanned before other image files in the queue.
